(19) United States
(12) Patent Application Publication
(10) Pub. No.: US 2004/0040406 A1
(43) Pub. Date: Mar. 4, 2004

(54) Detachable bicycle training push handle

(76) Inventor: Walter G. Hahn, Alpharetta, GA (US)

Correspondence Address: WALTER G. HAHN, 396 S. MILL VIEW WAY, PONTE VEDREA BEACH, FL, 32082, US

(21) Appl. No.: 10/127,429

(22) Filed: Aug. 30, 2002

(51) Int. Cl. G05G 1/00

(52) U.S. Cl. 74/544

(57) ABSTRACT

A tube with a handle that attaches and detaches from a toddlers two wheel bicycle fitted with training wheels.

Ball (3) which is attached to the end of tube (FIG. 4) is fitted into ballshaft through-hole (2) and is kept in place with Carabiner (FIG. 6).

To remove ball (3) and tube (FIG. 4), Carabiner (FIG. 6) is removed making room for ball (3) to be free of ballshaft through-hole (2).

This attachment and detachment process will only leave seat bracket (FIG. 1) bolted to the bicycle seat height adjustment clamp (FIG. 7).

### CROSS-REFERENCE TO RELATED APPLICATIONS

This invention is related to my previously incomplete nonprovisional application. Application Ser. No. 10/127,429 and Customer Number 33423 Filed Apr. 22, 2002.

### BACKGROUND—FIELD OF INVENTION

This invention relates to bicycle riding training devices, specifically to such devices which are used to manually enhance and/or slow the momentum of a two wheel bicycle that is previously fitted with training wheels.

### BACKGROUND—DESCRIPTION OF PRIOR ART

Some bicycle and toy manufacturers offer a model of tricycle with a handle that is permanently fixed to the frame of the tricycle. The purpose of their handle is to help an adult control the velocity of the tricycle as the child is learning to ride it. This design has two main drawbacks.

(a) Their handle is specific to tricycles.

Many people prefer to teach their children to ride a two wheel bicycle fitted with training-wheels from the beginning and not a tricycle. These people will also desire a handle that will allow them to control the velocity of the bicycle.

(b) Their handle is permanent and can not be easily removed.

When the child has achieved the sufficient skills for bicycle riding and no longer requires propulsion help from an adult, It will not be necessary to purchase a new bicycle that is not equipped with a permanent handle.

### SUMMARY

In accordance with the present invention a bicycle training push handle comprises a handle an extension and way of attachment to a bicycle.

### OBJECTS AND ADVANTAGES

Accordingly, besides the objects and advantages of the Detachable Bicycle Training Push Handle described in my above patent, a few other objects and advantages of the present invention are:

(a) to manually assist a child in maintaining a controlled velocity while he is first learning to direct and propel a two wheel bicycle that is fitted with training wheels. The adult will push the handle on uphill and hold-back on downhill slopes.

(b) to prevent uncomfortable forward or back pressure on the child's body while attempting to control the bicycles velocity.

(c) to help relieve the adults physical stress if he or she should need to bend at the waist to achieve the same level of velocity control.

(d) to help train the child's muscles to the peddling motion.

(e) to help the child learn to direct the two wheel bicycle fitted with training wheels in a more safe environment.

(f) to help the adult and child better enjoy the time they spend learning to ride a two wheel bicycle fitted with training wheels.

### DRAWING FIGURES

FIG. 1 shows a seat bracket supplied with bolt through-holes and ballshaft through hole.

FIG. 2 shows a ballshaft supplied with ball and threaded shaft

FIG. 3 shows a tubeplug supplied with threaded hole

FIG. 4 shows a tube supplied with bend

FIG. 5 shows a bicycle grip handle

FIG. 6 shows a Carabiner clip

FIG. 7 shows a bicycle seat height adjustment clamp

FIG. 8 shows an exploded view of the detachable bicycle training push handle

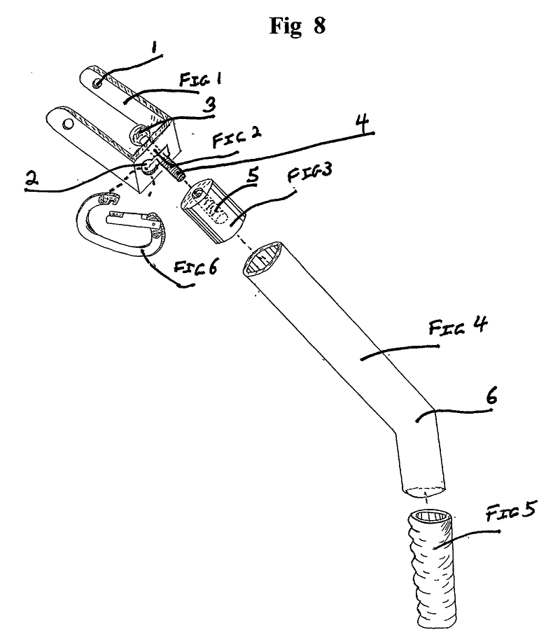

FIG. 9 shows an exploded view of the detachable bicycle training push handle supplied with the seat height adjustment clip

FIG. 10 shows an exploded view of a seat bracket, ballshaft, carabiner, tubeplug, and tube.

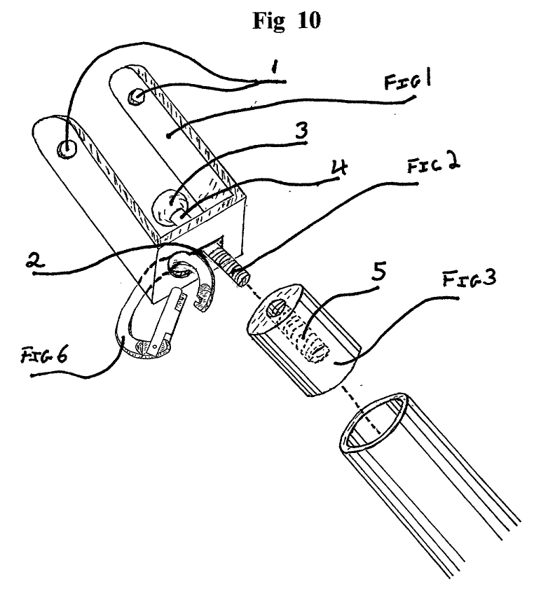

### REFERENCE NUMERALS IN DRAWINGS

1 Bolt Through—hole for seat bracket

2 Ballshaft Through—hole

3 Ball

4 Shaft

5 Threaded hole

6 Bend

7 Bolt through—hole for seat clamp

8 Bolt

### DESCRIPTION

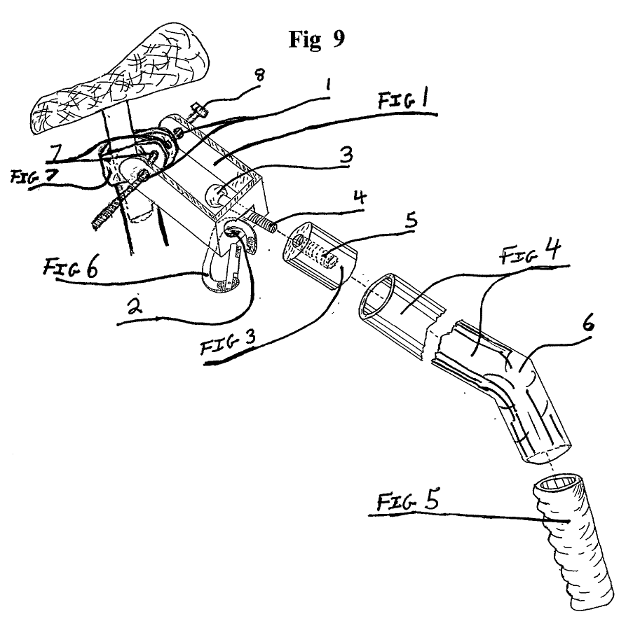

A preferred embodiment of the detachable bicycle training push handle is illustrated in FIG. 9.

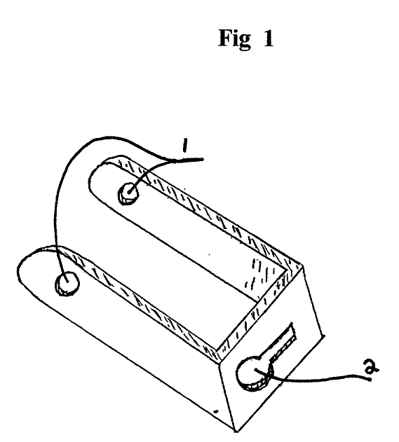

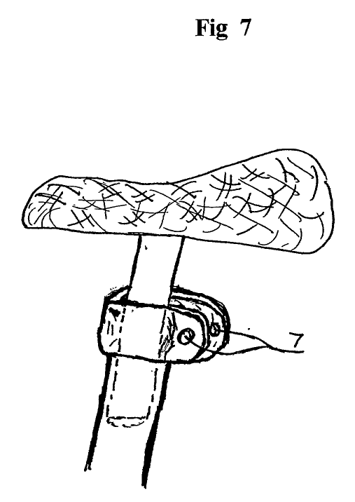

The handle has a seat bracket (FIG. 1) which is bolted to the bicycle at the seat height adjustment clamp (FIG. 7) using bolt through-holes 1 (FIG. 1) and bolt through-holes 7 (FIG. 7) with bolt 8 (FIG. 9).

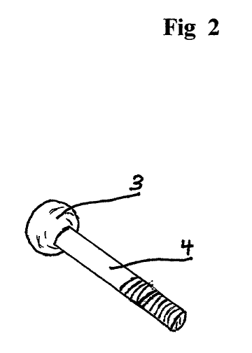

A ballshaft (FIG. 2) fits into a ballshaft through-hole 2 (FIG. 1).

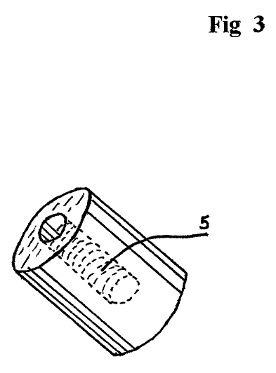

Ballshaft (FIG. 2) is threaded into tubeplug (FIG. 3) by mating threaded shaft 4 (FIG. 2) with threaded hole 5 (FIG. 3).

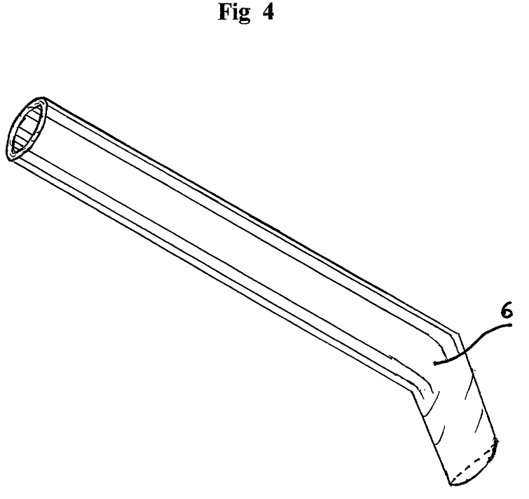

Tubeplug (FIG. 3) fits into tube (FIG. 4) and is secured with an adhesive.

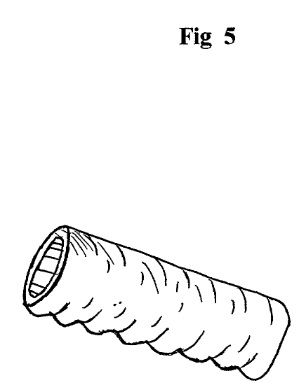

Tube (FIG. 4) is bent 6 (FIG. 4) where a bicycle grip (FIG. 5) will slide onto tube (FIG. 4).

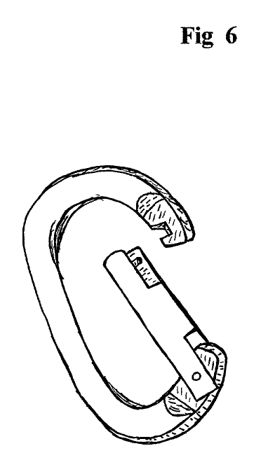

Ball 3 (FIG. 1) is prevented from sliding out of ballshaft through-hole 2 (FIG. 1) with carabiner clip (FIG. 6).

1. A hand-held shaft and handle for use by an adult that will attach and detach from a toddlers two wheel bicycle which is fitted with training wheels. To allow for:
a. Safety control over the bicycles velocity.
b. Comfort control over the training process.
